(19) United States
(12) Patent Application Publication
(10) Pub. No.: US 2013/0320801 A1
(43) Pub. Date: Dec. 5, 2013

(54) SPLIT CORE AND STATOR CORE

(71) Applicants: Akira Takasaki, Toyota-shi (JP); Hiroyuki Ikuta, Anjo-shi (JP)

(72) Inventors: Akira Takasaki, Toyota-shi (JP); Hiroyuki Ikuta, Anjo-shi (JP)

(73) Assignee: TOYOTA JIDOSHA KABUSHIKI KAISHA, Toyota-shi (JP)

(21) Appl. No.: 13/984,978

(22) PCT Filed: Feb. 13, 2012
(86) PCT No.: PCT/IB12/00248

§ 371 Date: Aug. 12, 2013

(30) Foreign Application Priority Data
Feb. 15, 2011 (JP) 2011-030055

(51) Int. Cl. H02K 1/16

(52) U.S. Cl. CPC H02K 1/16
USPC 310/216.009

(57) ABSTRACT

A split core of the invention is formed from a plurality of magnetic steel sheets that are stacked in a thickness direction and joined together by crimping, and that when provided in plurality, forms a stator core by being arranged in a circle. This split core includes a yoke that extends in a circumferential direction; a tooth that extends radially inward from an inner peripheral side end portion of the yoke; and an abutting portion that is formed on a joining surface of the yoke that joins with a yoke of another adjacent split core. A radial crimping portion that is longer in a radial direction and is positioned to an outer peripheral side of a maximum outer radius of the abutting portion, and that is crimped to a crimping portion of another magnetic steel sheet, is provided on each of the magnetic steel sheets.

### BACKGROUND OF THE INVENTION

1. Field of the Invention

The invention relates to a split core that is formed from a plurality of magnetic steel sheets that are stacked in a thickness direction and joined together by crimping, and that when provided in plurality, forms a stator core by being arranged in a circle. The invention also relates to a stator core formed by a plurality of the split cores.

2. Description of Related Art

A stator core of a rotary electric machine or the like is known that is formed by stacked steel sheets, in which a plurality of magnetic steel sheets are stacked together. With this stacked steel sheet type stator core, a crimping portion formed by a recessed portion when viewed from one surface and a protruding portion when viewed from the other surface, is formed on each magnetic steel sheet, and the crimping portion on one magnetic metal sheet is crimped to the crimping portion on another magnetic metal sheet in order to join the stacked magnetic steel sheets together.

Various technologies have been proposed regarding the structure of this crimping portion. For example, Japanese Patent Application Publication No. 2003-153474 (JP-A-2003-153474) describes technology that, in a core having an annular outer ring portion and a plurality of salient pole teeth that extend radially inward from an inner peripheral side of the outer ring portion, joins a plurality of magnetic steel sheets together by forming annular crimping portions along the outer shape of the outer ring portion, and crimping these crimping portions together. This technology is able to reduce disturbance of magnetic flux in the thin sheets.

However, as in JP-A-2003-153474, the annular crimping portions along the outer shape of the outer ring portion are effective with a one-piece core that is not split in the circumferential direction, but is unsuitable for a split core that is formed by arranging a plurality of core pieces in the circumferential direction. That is, when annular crimping portions along the outer shape are used in a split core, the restraining force in the stacking direction on the inner peripheral side of the core pieces decreases, so the stacked magnetic steel sheets tend to spread apart on the inner peripheral side, and as a result, the shape on the inner peripheral side becomes unstable.

Thus, Japanese Patent Application Publication No. 2008-043102 (JP-A-2008-043102), Japanese Patent Application Publication No. 2007-037367 (JP-A-2007-037367), and Japanese Patent Application Publication No. 2005-094959 (JP-A-2005-094959) describe technology in which crimping portions are provided on the inner peripheral side as well. Therefore, the magnetic steel sheets are able to be reliably restrained on the inner peripheral side as well. However, with the technologies described in JP-A-2008-043102 and JP-A-2007-037367, the crimping portions are positioned in the main path of the magnetic flux, and as a result, adversely affect the magnetic property, and thus may lead to a large loss. Also, the technology described in JP-A-2005-094959 is technology related to a one-piece core, and is thus difficult to apply to a split core. That is, there has not been a split core in which deterioration of the magnetic property is able to be prevented, while the core shape is able to be stably maintained.

### SUMMARY OF THE INVENTION

Therefore, the invention provides both a split core in which deterioration of the magnetic property is able to be prevented while the core shape is able to be stably maintained, and a stator core.

A first aspect of the invention relates to a split core that is formed from a plurality of magnetic steel sheets that are stacked in a thickness direction and joined together by crimping, and that when provided in plurality, forms a stator core by being arranged in a circle. This split core includes a yoke that extends in a circumferential direction; a tooth that extends radially inward from an inner peripheral side end portion of the yoke; and an abutting portion that is formed on a joining surface of the yoke that joins with a yoke of another adjacent split core, and that is fitted together with an abutting portion of the yoke of the other split core. A radial crimping portion that is longer in a radial direction than in a circumferential direction and is positioned to an outer peripheral side of a maximum outer radius of the abutting portion, and that is crimped to a crimping portion of another magnetic steel sheet, is provided on each of the magnetic steel sheets.

In this aspect, two of the radial crimping portions may be provided, one near each circumferential end of the yoke, on each of the magnetic steel sheets. Also, when a central angle of the split core is θ, the radial crimping portion may be provided in a range of θ/4 from a circumferential end portion of the yoke.

In the structure described above, a circumferential crimping portion that is longer in a circumferential direction than in a radial direction and is positioned to the outer peripheral side of the maximum outer radius of the abutting portion, and that is crimped to a crimping portion of another magnetic steel sheet, may further be provided on each of the magnetic steel sheets. In this case, the circumferential crimping portion may be provided between two radial crimping portions that are provided one near each circumferential end of the yoke.

A second aspect of the invention relates to a stator core. This stator core includes a plurality of split cores, each of which is formed from a plurality of magnetic steel sheets that are stacked in a thickness direction and joined together by crimping, and that are arranged in a circle. Each stator core includes a yoke that extends in a circumferential direction; a tooth that extends radially inward from an inner peripheral side end portion of the yoke; and an abutting portion that is formed on a joining surface of the yoke that joins with a yoke of another adjacent split core, and that is fitted together with an abutting portion of the yoke of the other split core. Also, a radial crimping portion that is longer in a radial direction than in a circumferential direction and is positioned to an outer peripheral side of a maximum outer radius of the abutting portion, and that is crimped to a crimping portion of another magnetic steel sheet, is provided on each of the magnetic steel sheets.

According to the aspect described above, the radial crimping portion that is long in the radial direction is provided to the outer peripheral side of the maximum outer radius of the abutting portion. The outer peripheral side of the maximum outer radius is a location where the flow of magnetic flux is small, so by providing the radial crimping portion in this position, deterioration of the magnetic property is able to be prevented, while the core shape is able to be stably maintained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a plan view of a portion of a stator core according to an example embodiment of the invention;

FIG. 2 is a plan view of the main portions of a split core according to the example embodiment;

FIG. 3 is a plan view of the main portions of the split core according to another example embodiment of the invention;

FIG. 4 is a plan view of the main portions of the split core according to yet another example embodiment of the invention;

FIG. 5 is a view of the flow of magnetic flux and the distribution of the magnetic flux density of the split core according the example embodiment;

FIG. 6 is a view of the distribution of compression stress applied to the split core according to the example embodiment;

FIGS. 7A and 7B are plan views of the main portions of a split core according to related art;

FIG. 8A is an image of a radial cross-section of the split core according to the example embodiment; and

FIG. 8B is an image of a radial cross-section of the split core shown in FIG. 7A.

### DETAILED DESCRIPTION OF EMBODIMENTS

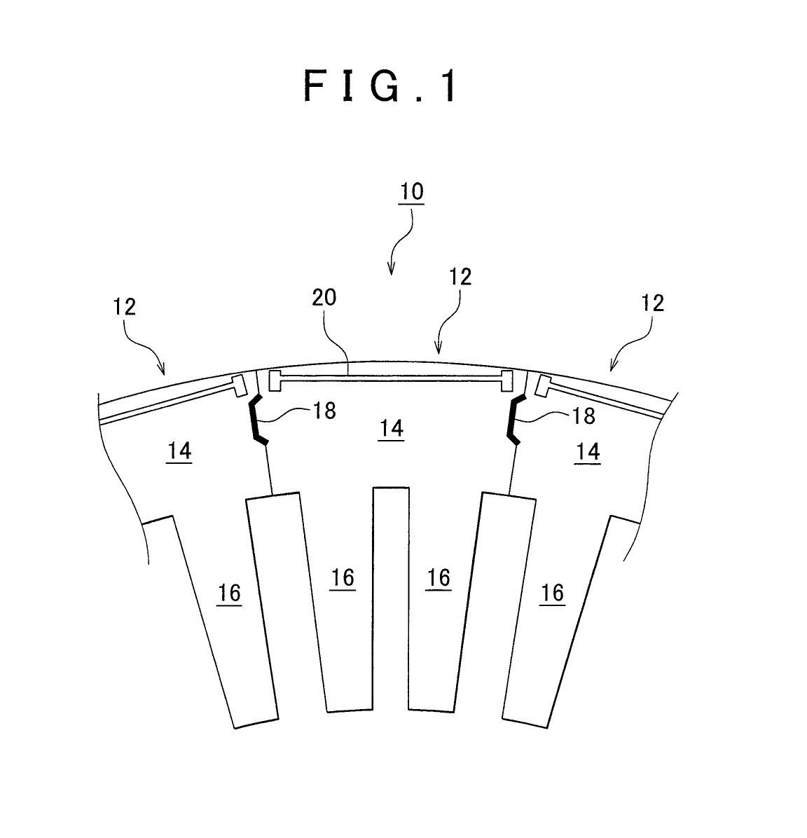

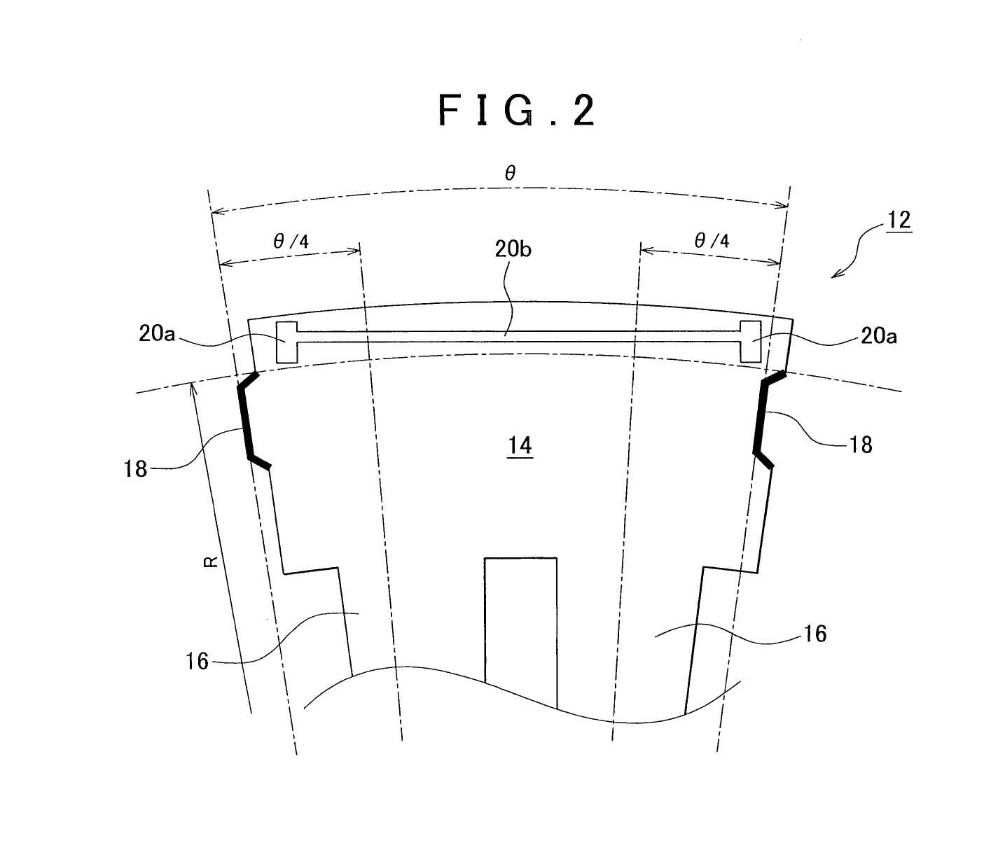

Hereinafter, example embodiments of the invention will be described with reference to the accompanying drawings. FIG. 1 is a plan view of a portion of a stator core 10 according to an example embodiment of the invention. Also, FIG. 2 is an expanded view of the main portions of a split core 12 that forms part of this stator core 10.

The stator core 10 in this example embodiment is used as a stator core in a rotary electric machine such as a motor or a generator, and is provided with an annular yoke portion. A plurality of teeth around which a coil, not shown, is wound protrude from the inner peripheral end of the yoke portion.

This stator core 10 is formed from a plurality of split cores 12. Each split core 12 is formed by stacking a plurality of magnetic steel sheets together in the thickness direction (i.e., the direction perpendicular to the surface of the paper on which FIG. 1 is drawn), and includes a yoke 14 that extends in the circumferential direction, and two teeth 16 that extend radially inward from the inner peripheral side end portion of the yoke 14.

An abutting portion 18 is provided on both end surfaces in the circumferential direction of the yoke 14, i.e., on joining surfaces where the split core 12 joins together with adjacent split cores 12. This abutting portion 18 is formed in either a protruding shape that protrudes in the circumferential direction or a recessed shape that is recessed in the circumferential direction, at a portion that fits together with an abutting portion 18 of another adjacent split core 12. When joining a plurality of split cores 12, this abutting portion 18 (protrusion or recess) fits together with the abutting portion 18 (recess or protrusion) of another adjacent split core 12 by a technique such as shrink fitting.

A plurality of magnetic steel sheets that make up each split core 12 are joined together by crimping. In order to realize this crimping, a crimping portion 20 is provided on each magnetic steel sheet. The crimping portion 20 is a recessed/protruding portion that is formed protruding on one side of the magnetic steel sheet and recessed on the other side of the magnetic steel sheet. The recess or protrusion of this crimping portion 20 fits together with the protrusion or recess of the crimping portion 20 of other magnetic steel sheets that are stacked above and below, such that the stacked magnetic steel sheet are joined together.

In this example embodiment, the crimping portion 20 is generally H-shaped, with a radial crimping portion 20a that is long in the radial direction connected to each end of a circumferential crimping portion 20b that is long in the circumferential direction, as shown in FIG. 2. Also, the circumferential crimping portion 20b and the radial crimping portions 20a are provided to the outside of a maximum outer radius R of the abutting portion 18. The reason for having the crimping portion 20 this way will be described in comparison to the related art.

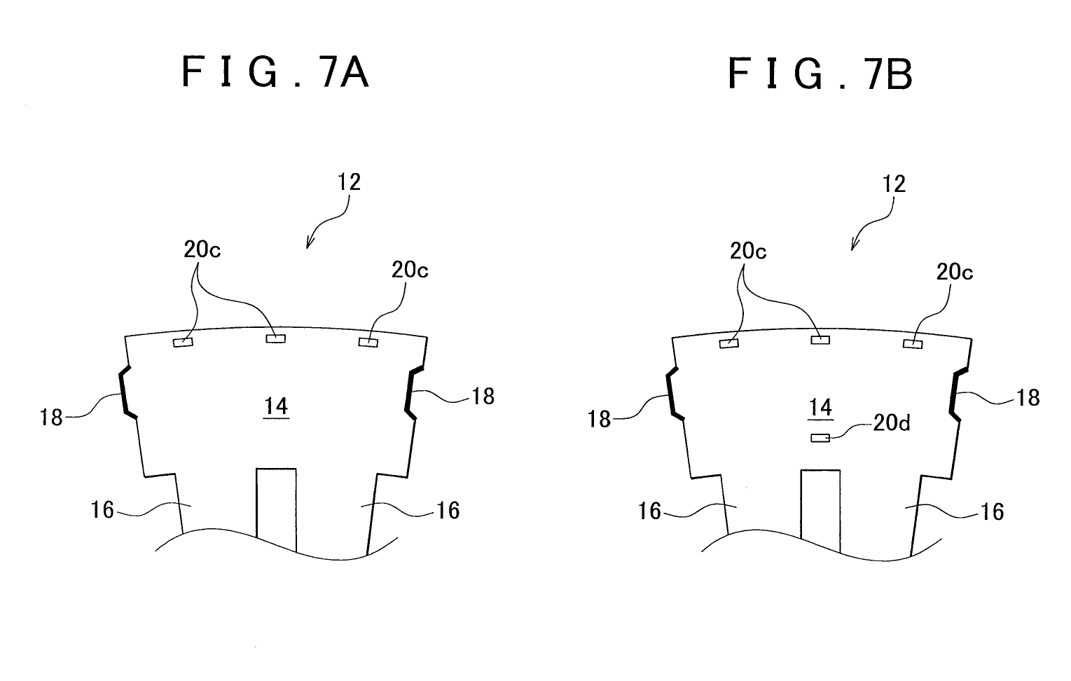

FIG. 7A is an enlarged view of the main portions of the split core 12 according to related art. The split core 12 of the related art is also formed from a plurality of magnetic steel sheets that have been stacked and joined together by crimping, similar to this example embodiment. In order to join the magnetic steel sheets together by crimping, a crimping portion 20c that protrudes on one side and is recessed on the other side is formed on each magnetic steel sheet. However, the crimping portion 20c on the magnetic steel sheets of the related art is often point-like and rectangular with a short length in the circumferential direction, as shown in FIG. 7A. In other words, the crimping portion 20 of the split core 12 according to the related art is often short in the radial direction. With the magnetic steel sheets of the related art, a plurality of these crimping portions 20c that are short in the radial direction are provided along the outer periphery of the yoke 14.

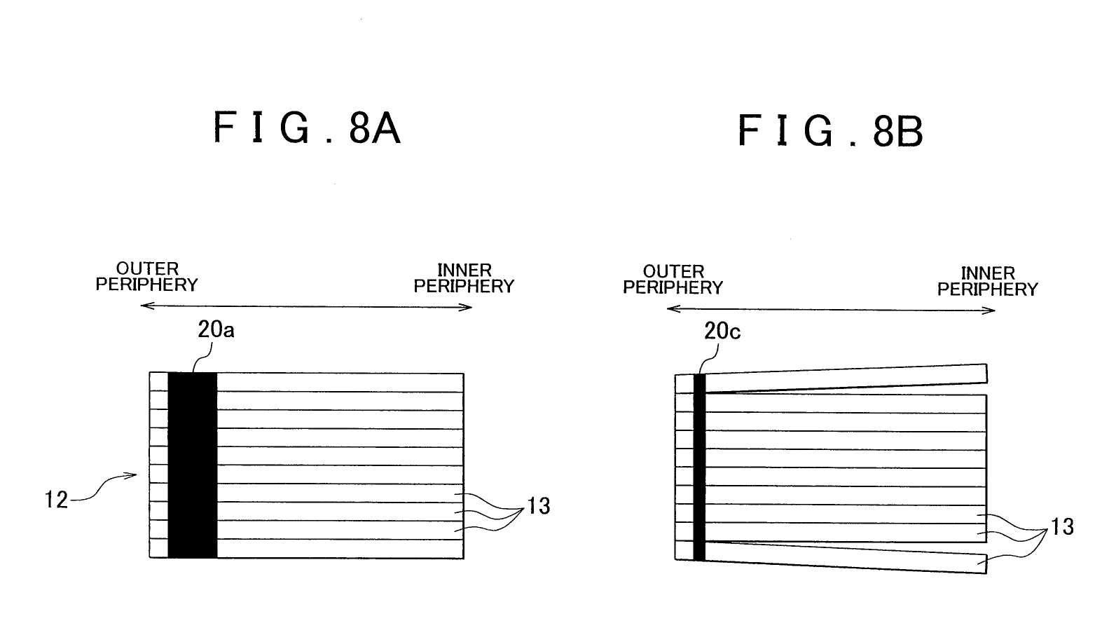

With these crimping portions 20, the shape of the stacked magnetic steel sheets is unstable, which is problematic. This will be described with reference to FIG. 8B. FIG. 8B is an image of a radial cross-section of the split core 12 of the related art. As shown in FIG. 8B, the crimping portions 20c of the split core 12 of the related art are often short in the radial direction. In this case, movement of the plurality of magnetic steel sheets can be prevented on the outer peripheral side where the crimping portions 20c are provided. However, on the inner peripheral side where the crimping portions 20c are not provided, the restraining force is insufficient, so the end portions of the stacked magnetic steel sheets may move and spread apart. As a result, the shape of the split core 12, and thus the stator core 10, is unstable, which is problematic.

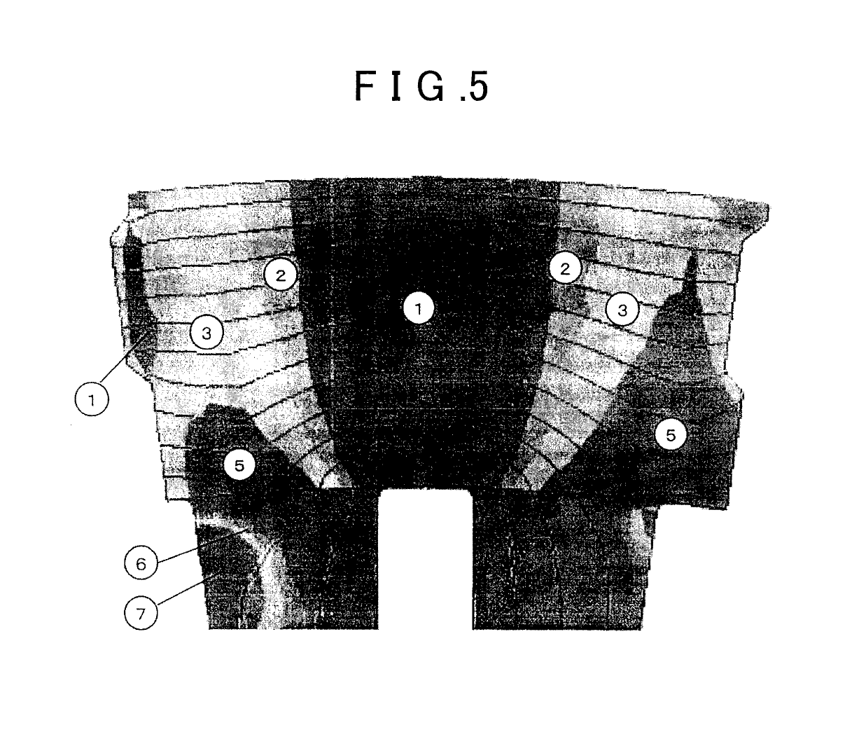

In order to minimize this problem, it has been proposed to provide a crimping portion 20d also near the inner periphery of the yoke 14, as shown in FIG. 7B. Providing the crimping portion 20d near the inner periphery of the yoke 14 makes it possible to ensure restraining force also near the inner periphery of the yoke 14, thus making it possible to keep the shape of the split core 12 stable. However, the crimping portion 20d at this position will disturb the magnetic flux, and as a result, may lead to a decrease in the efficiency of the rotary electric machine or the like in which the stator core 10 is used. This will be described with reference to FIG. 5.

FIG. 5 is a view of the flow of magnetic flux and the distribution of the magnetic flux density when the split core 12 is used as the stator core 10 of a rotary electric machine. In FIG. 5, the circled numbers indicate the height of the magnetic flux density. Areas with a smaller value number are areas with a higher magnetic flux density. Also, the lines running inside the split core in FIG. 5 represent the flow of magnetic flux. As is apparent from FIG. 5, normally, the magnetic flux mainly flows along a path from one tooth 16 to another tooth 16 through an area near the inner peripheral end of the yoke 14, and a path from the abutting portion 18 provided on one end of the yoke 14 to the abutting portion 18 provided on the other end of the yoke 14. That is, the area near the inner periphery of the yoke 14 can be said to be a main pathway of the magnetic flux. When the crimping portion 20d shown in FIG. 7B is provided near the inner peripheral end of the yoke 14 that is a pathway of the magnetic flux, it creates a disturbance in the magnetic flux, and as a result, leads to problems such as a decrease in the efficiency of the rotary electric motor.

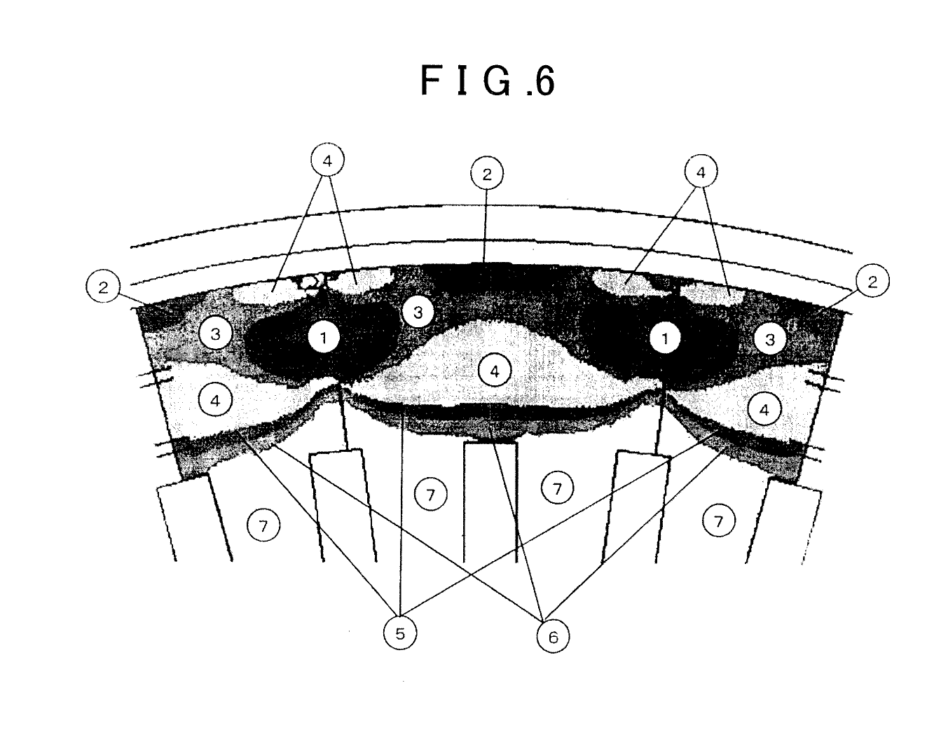

Also, the position of the crimping portion is obtained taking not only the flow of the magnetic flux described above, but also the distribution of compression stress that accompanies shrink fitting, into account. That is, the split cores 12 are connected together by fitting the abutting portions 18 that are provided on the circumferential end portions of the yokes 14 together by shrink fitting as described above. In this case, compression stress is applied to the split cores 12 with a distribution such as that shown in FIG. 6. FIG. 6 is a view of the distribution of compression stress in the split cores 12 after shrink fitting. In FIG. 6, the circled numbers indicate the amount of compression stress. Areas with a smaller value number are areas where more compression stress is being applied.

As is evident from FIG. 6, with shrink fitting, a large amount of compression stress is applied to the area around the abutting portion 18. If the crimping portions 20 are provided at these locations where a large amount of compression stress is applied, and magnetic steel sheets are crimped together at these locations, this crimping will cause even more compression stress to be applied, and as a result, locations where an extremely large amount of compression stress is applied will be created. This kind of compression stress leads to deterioration of the magnetic property (i.e., iron loss and magnetization property) of the yoke 14, and thus reduces the efficiency of the rotary electric machine and the like.

In this example embodiment, in order to avoid this problem, the crimping portions 20 are provided to the outside of the maximum outer radius R of the abutting portion 18, as described above. That is, as described with reference to FIG. 5, much of the magnetic flux passes through a magnetic path from one tooth 16 to another tooth 16 via an area near the inner peripheral end of the yoke 14, and a magnetic path from one abutting portion 18 to another abutting portion 18. In other words, the flow of magnetic flux is less in locations to the outer peripheral side of the abutting portion 18. When the crimping portions 20 are provided in these locations, disturbance to the magnetic flux that is caused by the crimping portions 20 can be minimized, and as a result, loss can be reduced.

Also, compression stress caused by shrink fitting the abutting portions 18 together is generated mainly around the abutting portions 18, and decreases to the outside of the maximum outer radius R. In this way, providing the crimping portions 20 to the outside of the maximum outer radius R where the affect of compression stress due to shrink fitting is small enables the compression stress that is applied to the split core 12 to be dispersed appropriately, and as a result, makes it possible to minimize problems such as the deterioration of the magnetic property (i.e., iron loss and magnetization property) of the yoke 14, and thus a reduction in the efficiency of the rotary electric machine and the like.

Also, in this example embodiment, the radial crimping portions 20a that are long in the radial direction are provided as the crimping portions 20. Providing these radial crimping portions 20a makes it possible to increase the restraining force in the radial direction, and thus enables the shape of the split core 12 to be stably maintained. This will be described with reference to FIG. 8A. FIG. 8A is an image of a radial cross-section of the split core 12 according to the example embodiment, while FIG. 8B is an image of a radial cross-section of the split core 12 shown in FIG. 7A.

As is evident by comparing FIGS. 8A and 8B, with the crimping portion 20c in which the length in the radial direction is short, the restraining amount in the radial direction tends to decrease. As a result, the restraining force on the inner peripheral side is insufficient, so magnetic steel sheets 13 move up and down. On the other hand, when the radial crimping portions 20a are shaped long in the radial direction, as in this example embodiment, a large restraining amount in the radial direction is able to be ensured. As a result, up and down movement of the magnetic steel sheets 13 is able to be effectively suppressed, so the shape of the split core 12 can be stably maintained. Also in this example embodiment, two of these radial crimping portions 20a are provided, one near each end in the circumferential direction of the yoke 14. More specifically, if the central angle of the split core 12 is θ, a radial crimping portion 20a is provided in a range of θ/4 from each circumferential end portion of the yoke 14. As a result, the effect of preventing up and down movement of the magnetic steel sheets 13 as described above is able to be displayed over the entire periphery, so the shape of the split core 12 is able to be more stably maintained.

Moreover, in this example embodiment, the circumferential crimping portion 20b that is long in the circumferential direction is also provided between these two radial crimping portions 20a. Providing this circumferential crimping portion 20b increases the binding force in the circumferential direction, thereby enabling the shape of the split core 12 to be even more stably maintained.

As is evident from the description above, with this example embodiment, the magnetic property can be prevented from deteriorating, while the shape of the split core 12 can be stably maintained. It should be noted that in this example embodiment, the crimping portion 20 is generally H-shaped, with the radial crimping portions 20a being connected to both ends of the straight circumferential crimping portion 20b. Alternatively, however, the crimping portion 20 may be any shape as long as it is provided to the outside of the maximum outer radius R and has a portion that is long in the radial direction.

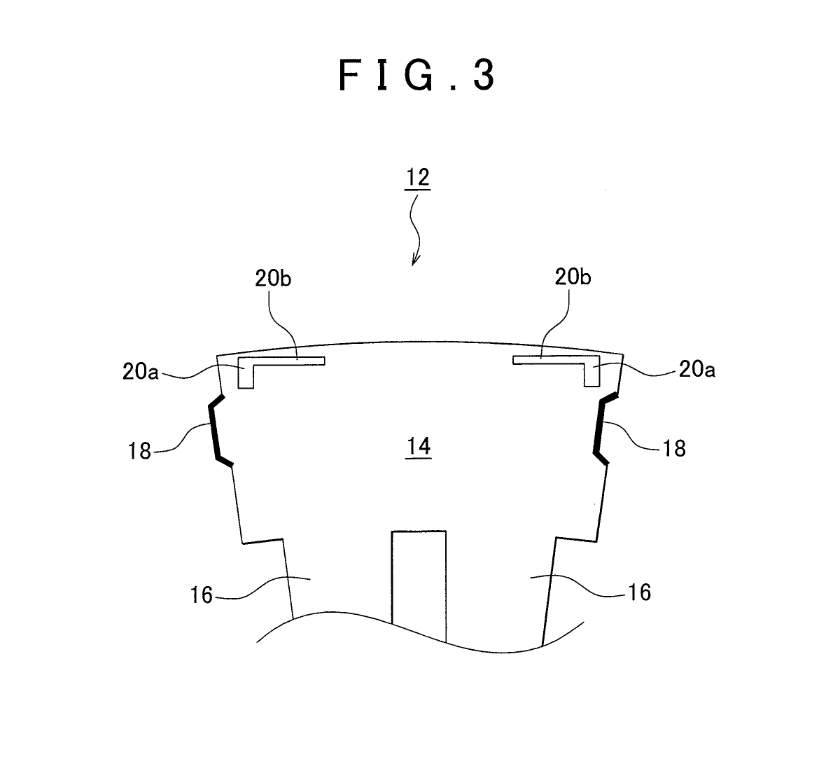

For example, a generally L-shaped crimping portion 20 in which a circumferential crimping portion 20b that is long in the circumferential direction is connected to an outer peripheral side end portion of a radial crimping portion 20a that is long in the radial direction, as shown in FIG. 3, may also be used. In this case, the generally L-shaped crimping portion 20 is preferably arranged so as to be bilaterally symmetrical, with one near each end in the circumferential direction of the yoke 14. Also, naturally, this generally L-shaped crimping portion 20 is arranged farther to the outside than the maximum outer radius R of the abutting portion 18. As a result, the magnetic property is able to be prevented from deteriorating, while the shape of the split core 12 is able to be stably maintained, just as in the example embodiment shown in FIG. 2.

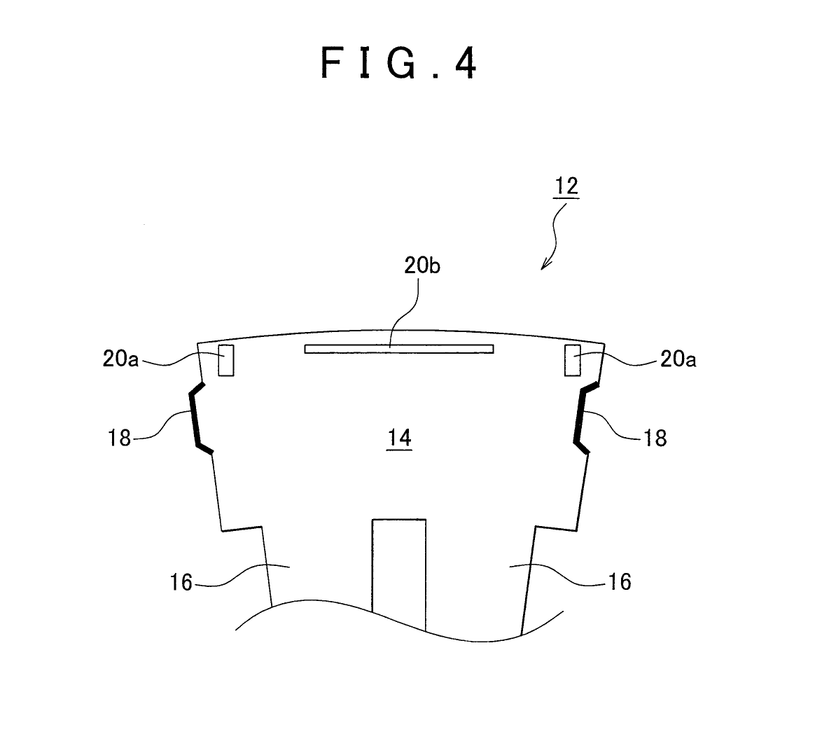

Also, as another example embodiment, the radial crimping portions 20a and the circumferential crimping portion 20b may also be provided separately, apart from one another. That is, two radial crimping portions 20a that are long in the radial direction are provided, one near each circumferential end of the yoke 14, and the circumferential crimping portion 20b that is long in the circumferential direction is provided between these two radial crimping portions 20a, as shown in FIG. 4. With this example embodiment as well, the magnetic property is able to be prevented from deteriorating, while the shape of the split core 12 is able to be stably maintained, just as in the example embodiment shown in FIG. 2. Furthermore, example embodiments other than those described above are also possible as long as at least one radial crimping portion 20a is provided farther to the outside than the maximum outer radius of the abutting portion 18.

1. A split core that is formed from a plurality of magnetic steel sheets that are stacked in a thickness direction and joined together by crimping, and that when provided in plurality, forms a stator core by being arranged in a circle, comprising:
a yoke that extends in a circumferential direction;
a tooth that extends radially inward from an inner peripheral side end portion of the yoke; and
an abutting portion that is formed on a joining surface of the yoke that joins with a yoke of another adjacent split core, and that is fitted together with an abutting portion of the yoke of the other split core,
wherein a radial crimping portion that is longer in a radial direction than in a circumferential direction and is positioned to an outer peripheral side of a maximum outer radius of the abutting portion, and that is crimped to a crimping portion of another magnetic steel sheet, is provided on each of the magnetic steel sheets;
a circumferential crimping portion that is longer in a circumferential direction than in a radial direction and is positioned to the outer peripheral side of the maximum outer radius of the abutting portion, and that is crimped to a crimping portion of another magnetic steel sheet, is further provided on each of the magnetic steel sheets; and
the circumferential crimping portion is provided between two radial crimping portions that are provided one near each circumferential end of the yoke.

2. The split core according to claim 1, wherein two of the radial crimping portions are provided, one near each circumferential end of the yoke, on each of the magnetic steel sheets.

3. The split core according to claim 1, wherein when a central angle of the split core is θ, the radial crimping portion is provided in a range of θ/4 from a circumferential end portion of the yoke.

4-5. (canceled)

6. The split core according to claim 1, wherein the crimping portion is generally H-shaped, with one of the two radial crimping portions connected to one end of the circumferential crimping portion, and the other of the two radial crimping portions connected to the other end of the circumferential crimping portion.

7. The split core according to claim 1, wherein the crimping portion is generally L-shaped, with the circumferential crimping portion connected to an outer peripheral side end portion of each of the radial crimping portions.

8. The split core according to claim 1, wherein the radial crimping portions and the circumferential crimping portion are apart from each other.

9. A stator core comprising:
a plurality of split cores, each of which is formed from a plurality of magnetic steel sheets that are stacked in a thickness direction and joined together by crimping, and that are arranged in a circle,
wherein each split core includes a yoke that extends in a circumferential direction; a tooth that extends radially inward from an inner peripheral side end portion of the yoke; and an abutting portion that is formed on a joining surface of the yoke that joins with a yoke of another adjacent split core, and that is fitted together with an abutting portion of the yoke of the other split core; and
wherein a radial crimping portion that is longer in a radial direction than in a circumferential direction and is positioned to an outer peripheral side of a maximum outer radius of the abutting portion, and that is crimped to a crimping portion of another magnetic steel sheet, is provided on each of the magnetic steel sheets;
a circumferential crimping portion that is longer in a circumferential direction than in a radial direction and is positioned to the outer peripheral side of the maximum outer radius of the abutting portion, and that is crimped to a crimping portion of another magnetic steel sheet, is further provided on each of the magnetic steel sheets; and
the circumferential crimping portion is provided between two radial crimping portions that are provided one near each circumferential end of the yoke.
